(19) United States
(12) Patent Application Publication
(10) Pub. No.: US 2026/0236872 A1
(43) Pub. Date: Aug. 13, 2026

(54) COMPUTING SYSTEM AND METHOD FOR BUILDING AND EXECUTING A FORECASTING MODEL FOR CALL CENTER CAPACITY SHRINKAGE

(71) Applicant: Capital One Financial Corporation, McLean, VA (US)

(72) Inventors: Siddharth Rajendra Oza, Bellevue, WA (US); Jiaxu He, Chicago, IL (US); Vritti Gandhi, Chicago, IL (US); Mahadevan Sambasivam, Chicago, IL (US)

(21) Appl. No.: 19/051,148

(22) Filed: Feb. 11, 2025

(51) Int. Cl. G06Q 10/0637; G06Q 10/04; G06Q 10/0639

(52) U.S. Cl. CPC G06Q 10/06375; G06Q 10/04; G06Q 10/0639

(57) ABSTRACT

A computing platform is configured to: (i) obtain historical data for capacity shrink rate for a call center workforce, (ii) obtain historical data for a set of exogenous variables including (a) call volume and (b) a set of agent tenure variables corresponding to agents of the call center workforce, each agent tenure variable identifying a proportion of agents having a respective tenure with the call center workforce, (iii) based on the historical data, generate a time-series model configured to predict forecast values for the capacity shrink rate, (iv) receive, as input to the time-series model, (a) predicted data for the call volume during a target timeframe and (b) predicted data for the set of agent tenure variables during the target timeframe, and (v) utilize the time-series model to predict a sequence of forecast values for the capacity shrink rate for the call center workforce during the target timeframe.

### BACKGROUND

Time-series data generally comprises a sequence of values for one or more data variables that are recorded over time, where each such data variable may be referred to as a “time-series variable.” Various organizations utilize time-series data to record and track how the values of certain time-series variables change over time, which may allow meaningful insights to be derived about the time-series variables themselves and perhaps also other data variables that are impacted by the time-series variables. For instance, based on an analysis of the recorded values for a time-series variable, temporal patterns may be identified and utilized to explain the past behavior of the time-series variable (and/or other data variables) or to forecast the future behavior of the time-series variable (and/or other data variables), among other possibilities.

### SUMMARY

Disclosed herein is new technology for building and executing machine learning forecasting models for predicting capacity shrinkage in call centers.

In one aspect, the disclosed software technology may take the form of a method to be carried out by a computing platform that involves (i) obtaining historical data for a capacity shrink rate for a call center workforce, (ii) obtaining historical data for a set of exogenous variables, the set of exogenous variables comprising (a) call volume for the call center workforce and (b) a set of agent tenure variables corresponding to agents of the call center workforce, each agent tenure variable identifying a proportion of the agents having a respective tenure with the call center workforce, (iii) based on the historical data for the capacity shrink rate for the call center workforce and the historical data for the set of exogenous variables, generating a time-series model that is configured to predict forecast values for the capacity shrink rate for the call center workforce during a target timeframe, (iv) receiving, as input to the time-series model, (a) predicted time series data for the call volume for the call center workforce during a given target timeframe and (b) predicted time series data for the set of agent tenure variables during the given target timeframe, and (v) utilizing the time-series model to predict a sequence of forecast values for the capacity shrink rate for the call center workforce during the given target timeframe.

In some examples, the method may also involve, before generating the time-series model, transforming the historical data for the set of agent tenure variables by segmenting it into two or more agent tenure windows, wherein each agent tenure variable identifies a proportion of agents of the call center workforce that falls within a corresponding agent tenure window

Further, in some examples, the two or more agent tenure windows comprise a first tenure window from 0 to 1 years, a second tenure window from 1 to 3 years, a third tenure window from 3 to 5 years, and a fourth tenure window of 5 years or greater.

Further, in some examples, generating a time-series model may involve (i) training a plurality of candidate time-series models that are configured to predict forecast values for the capacity shrink rate for the call center workforce, wherein each time-series model in the plurality has a different hyperparameter combination, (ii) based on an evaluation of the plurality of candidate time-series models, determining a respective measure of performance for each of the different hyperparameter combinations, (iii) identifying a hyperparameter combination that has a best measure of performance relative to other hyperparameter combinations, and (iv) selecting a candidate time-series model having the identified hyperparameter combination as the generated time-series model.

Still further, in some examples, the different hyperparameter combinations are selected using grid search.

Still further, in some examples, determining a respective measure of performance for each different hyperparameter combination may involve determining, for each different hyperparameter combination, a respective mean absolute percentage error (MAPE) value.

Still further, in some examples, the set of exogenous variables further comprises one or more of (iii) agent geographic location for agents of the call center workforce, (iv) agent pay grade for agents of the call center workforce, or (vi) team leader tenure for agents of the call center workforce.

Still further, in some examples, the method may also involve determining a set of current values for the set of agent tenure variables, wherein the predicted time series data for the set of agent tenure variables during the given target timeframe comprises the set of current values for the set of agent tenure variables.

Still further, in some examples, the method may also involve receiving, from a client device, input indicating (i) the historical data for the capacity shrink rate and (ii) the historical data for a set of exogenous variables and transmitting the predicted sequence of forecast values for the capacity shrink rate for the call center workforce during the target timeframe to the client station for display via the client station.

In another aspect, disclosed herein is a computing platform that includes at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In yet another aspect, disclosed herein is a non-transitory computer-readable medium that is provisioned with program instructions that are executable to cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts one illustrative example of a computing environment in which the disclosed time-series forecasting tool may be implemented.

FIG. 2 depicts a schematic diagram showing one possible example of segmenting historical agent tenure data into two or more agent tenure windows.

FIG. 3 depicts a simplified block diagram showing example inputs to, and outputs from, a model building component and a model execution component in accordance with the present disclosure.

FIG. 4 is a flowchart that illustrates example functionality that may be carried out by a computing platform to build and execute a time-series forecasting model in accordance with the present disclosure.

FIG. 5 is a simplified block diagram illustrating some structural components of an example computing platform.

FIG. 6 is a simplified block diagram illustrating some structural components of an example client device.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

As noted above, time-series data generally includes a sequence of values for one or more data variables that are recorded over time, where each such data variable may be referred to as a “time-series variable.” For instance, time-series data comprising a single time-series variable (which may be referred to as “univariate time-series data”) may take the form of a two-dimensional dataset wherein a first dimension represents time and a second dimension represents the value of the time-series variable. Along similar lines, time-series data comprising multiple time-series variables (which may be referred to as “multivariate time-series data”) may take the form of a multi-dimensional dataset wherein a first dimension represents time and then the other dimensions represent the values of the multiple time-series variables. In time-series datasets, the values for each time-series variable are typically recorded at regular time intervals, examples of which may include hourly intervals, daily intervals, weekly intervals, monthly intervals, or yearly intervals, among other possible examples, which allows an interested party to track the changes in the time-series variable's value over time. Some representative examples of time-series variables include data variables related to sales volume, call center volume, transaction volume, inventory, stock prices, interest rates, income, spending habits, computer and/or networking activity (e.g., observability metrics), population, weather tracking (e.g., temperature, rainfall, etc.), and health tracking (e.g., weight, heart rate, etc.), among many others.

Various business organizations utilize time-series data to record and track how the values of certain time-series variables impact the business organization's operations change over time. This may allow meaningful insights to be derived about the time-series variables themselves and perhaps also other data variables that are impacted by the time-series variables. For instance, based on an analysis of the recorded values for a time-series variable, temporal patterns may be identified and utilized to explain the past behavior of the time-series variable (and/or other data variables) or to forecast the future behavior of the time-series variable (and/or other data variables), among other possibilities.

One example area in which business organizations may utilize timer-series data is in the operation of call centers that provide support for customers of the business organization. In this regard, a business organization may track the values of certain time-series variables related to the call center. One such time-series variable related to a call center's operation is incoming call volume (e.g., number of calls offered (NCO)) over time. By tracking and analyzing time-series data related to call volume a business organization may derive meaningful insights related to changes in call volume over time, as well as forecast future values for the call center's call volume. Such forecasts may allow the business organization to better plan for the workforce operations of the call center, including determining the number of full-time agents that will need to be working in a future time period to handle the expected call volume during that time period.

However, call volume is not the only variable that is considered for workforce planning. Another important consideration is capacity shrinkage, or shrink rate, which refers to time that agents are unavailable for customer-facing activities due to factors such as breaks, training, unscheduled absences, and other non-productive time. For example, if an agent is scheduled to work an 8-hour shift, the agent may only be available and working for 6 of those hours, which corresponds to a capacity shrink rate of 25% (i.e., the agent is unavailable for 2 of the 8 scheduled hours). Capacity shrink rate is a critical component used to determine staffing levels and future hiring needs and must be considered to avoid under-or over-staffing the call center's workforce, as both can have negative operational and financial implications.

Various computer-based technologies currently exist for analyzing and forecasting time-series data. For instance, various complex, computer-based technologies currently exist for generating time-series forecasting models that are configured to forecast future values of a time-series variable, including but not limited to technologies for training time-series forecasting models using a regression technique or some other machine learning technique (e.g., a neural network) and tuning the hyperparameters of such time-series models using a technique such as grid search or random search. In practice, these technologies involve advanced functionality that requires the use of high-powered computers and typically utilize large volumes of complex time-series data that cannot be practically evaluated by humans.

However, existing approaches for predicting capacity shrink rate in call centers have a various drawbacks and problems. As one example, some business organizations do not use a data driven approach at all to predict capacity shrinkage, and instead estimate capacity shrink rates based on subjective judgments, perhaps combined with anecdotal historical shrinkage values. For instance, a workforce manager may utilize a fixed shrinkage value (e.g., 20%) to estimate all future staffing needs, and then adjust this value for future time periods during which some deviation is anticipated (e.g., due to holidays or other events) based on their experience and intuition. Such approaches lack repeatability and are difficult to scale. Moreover, they rely on the knowledge of relatively few experienced individuals, which can be highly problematic if those individuals leave.

As another example of the shortcomings of existing approaches, some business organizations that use computer-based technologies for analyzing and forecasting time-series data may simply track historical shrinkage values in spreadsheets and then rely on extrapolation of recent trends to predict future capacity shrink rates. Similarly, some business organizations use existing computer-based technologies to develop time-series models for forecasting capacity shrink rate. However, these are also based solely on trends in recent historical data for capacity shrink rate (e.g., a 3-month moving average). These types of approaches do not consider the influence of other exogenous variables that may impact capacity shrink rate in the future. For example, certain exogenous variables may affect the makeup of the call center workforce on which the historical capacity shrink rate data is based. As the values of these exogenous variables change in the future, they may have some effect on the future capacity shrink rate for the call center. However, approaches for forecasting capacity shrink rate that only consider historical trends do not account for these types of changes in exogenous variables that may influence the capacity shrink rate. Moreover, approaches for forecasting capacity shrink rate that only consider historical data within a relatively recent look-back window, such as the most recent 3 months, may not capture longer trends in the capacity shrink rate.

Further, to the extent that some current computer-based technologies for analyzing and forecasting time-series data may allow for the incorporation of exogenous variables into a time-series forecast, these computer-based technologies provide no indication of what exogenous variables might be most useful in predicting the capacity shrink rate for call centers.

The existing computer-based technologies for analyzing and forecasting time-series data for capacity shrinkage in call centers suffer from other problems as well.

To address these and other problems with the existing technology for analyzing and forecasting time-series data related to call center capacity shrinkage, disclosed herein is a new framework for building and executing time-series forecasting models for predicting forecast values for the capacity shrink rate within a call center workforce. In practice, the disclosed model building and execution framework may be implemented by a software application that is hosted on a back-end computing platform and is accessible by client devices over a communication path that typically includes the Internet (among other data networks that may be included). In this respect, the disclosed model building and execution framework may be implemented by server-side software installed on the back-end computing platform as well as client-side software that runs on the client devices and interacts with the server-side software, which could take the form of a client application running in a web browser (sometimes referred to as a “web application”), a native desktop application, or a mobile application, among other possibilities. However, the disclosed model building and execution framework could take other forms and/or be implemented in other manners as well.

At a high level, the disclosed model building and execution framework for predicting forecast values for the capacity shrink rate within a call center workforce may include functionality for incorporating several exogenous variables (also referred to as regressors) that uniquely influence capacity shrink rate. In this regard, the disclosed model building and execution framework incorporates as exogenous variables both historical and predicted data for various characteristics of the call center workforce. In particular, a measure of agent tenure is used as a regressor in the building and execution of the time-series models discussed herein, which can lead to more accurate forecasts. For instance, the inventors have found that median capacity shrink rate and the spread of shrink rates tends to decrease as agent tenure increases, although more agents are likely to be outliers as tenure increases. Other exogenous variables corresponding to agent characteristics are also contemplated, including geographic location, pay grade, and the tenure of an agent's team leader, among other possibilities.

Further, the disclosed model building and execution framework incorporates both historical and predicted data for call volume as an exogenous variable, as it can also influence capacity shrink rate. In particular, the inventors have found that, in general, as call volume increases, capacity shrink rate also tends to increase. The relationship between call volume and capacity shrink rate may be based on various factors. As one possibility, predicted call volume may be impacted by a business organization's marketing plans and overall business strategy. For example, if a business organization implements a strategy that involves increased marketing spend in order to drive consumer engagement (e.g., new account requests, new loan requests, etc.), then call volume may be expected to increase due to increased consumer engagement. These same factors that may be expected to lead to increased call volume may impact hiring strategy for the business organization's call center(s), as more agents may be needed to handle the expected increase in call volume. This, in turn, may impact the tenure distribution among agents in the call center(s), as an increase in newly hired agents may result in a greater proportion of agents that have less tenure. This, as noted above, may generally correspond to an increase in capacity shrink rate among the call center workforce.

In addition, the time-series models generated according to the disclosed framework incorporate a larger look-back window of historical data that current approaches, and in doing so are able to analyze seasonal trends across various different time scales, including daily, weekly, monthly, and/or yearly seasonal trends.

The disclosed model building and execution framework improves upon existing computer-based technologies for analyzing and forecasting time-series data for capacity shrink rate in a number of ways. Foremost, the disclosed framework provides a more accurate, data driven approach for forecasting capacity shrink rates, which in turn supports workforce management via improved planning of staff schedules and increased operational efficiency while maintaining desired customer service levels. Further, including agent tenure as an exogenous variable in the time-series model allows for improved insights into both capacity shrinkage and workforce management, allowing organizations to better quantify the effects of new hiring initiatives and other workforce-related decisions. By incorporating a combination of historical trends, seasonal patterns, and specific exogenous variables that drive capacity shrink rate, business organizations are able to more effectively balance staffing supply with call volume demand.

As discussed below, the disclosed model building and execution framework improves upon existing technologies for predicting capacity shrinkage in a call center workforce in various other ways as well.

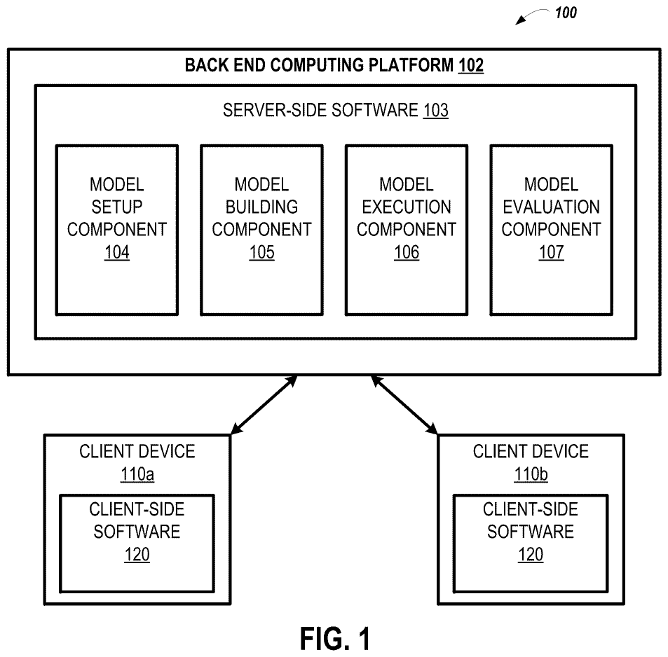

Turning now to the figures, FIG. 1 depicts one illustrative example of a computing environment 100 in which the disclosed model building and execution framework may be implemented. As shown, the computing environment 100 may include a back-end computing platform 102 and a plurality of client devices 110, of which client devices 110a and 110b are shown as examples.

The back-end computing platform 102 may comprise any one or more computer systems (e.g., one or more servers) that have been installed with server-side software 103, which may configure the back-end computing platform 102 to carry out the server-side functionality disclosed herein. For purposes of illustration and discussion, server-side software 103 is shown as including a model setup component 104, a model building component 105, a model execution component 106, and a model evaluation component 107, but it should be understood that server-side software 103 could take various other forms as well.

In practice, the one or more computer systems of the back-end computing platform 102 may collectively comprise some set of physical computing resources (e.g., one or more processors, data storage systems, communication interfaces, etc.), which may take any of various forms. As one possibility, the back-end computing platform 102 may comprise cloud computing resources supplied by a third-party provider of “on demand” cloud computing resources, such as Amazon Web Services (AWS), Amazon Lambda, Google Cloud, Microsoft Azure, or the like. As another possibility, the back-end computing platform 102 may comprise “on-premises” computing resources of organization that operates the back-end computing platform 102 (e.g., servers owned by the organization that operates the back-end computing platform 102). As yet another possibility, the back-end computing platform 102 may comprise a combination of cloud computing resources and on-premises computing resources. Other implementations of the back-end computing platform 102 are possible as well.

Further, in practice, the server-side software 103 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the server-side software 103 may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The example back-end computing platform 102 may comprise various other components and take various other forms as well.

Turning to the client devices 110, in general, each of example client devices 110a, 110b may take the form of any computing device that is capable of running client-side software 120, which may configure the client device to carry out the client-side functionality disclosed herein. As noted above, the client-side software may take the form of a client application that runs in a web browser, a native desktop application, or a mobile application, among other possibilities. In this respect, each of example client devices 110a, 110b may include hardware components such as one or more processors, data storage, communication interfaces, and input/output (I/O) components (or interfaces for connecting thereto), among other possible hardware components, as well as software components such as operating system (OS) software, web browser software, and/or the client-side software 120, among other possible software components. As representative examples, each of example client devices 110a, 110b may take the form of a desktop computer, a laptop, a netbook, a tablet, a smartphone, or a personal digital assistant (PDA), among other possibilities.

As further depicted in FIG. 1, each of example client devices 110a, 110b may be configured to communicate with the back-end computing platform 102 over a respective communication path. Each of these communication paths may generally comprise one or more data networks and/or data links, which may take any of various forms. For instance, each respective communication path between an example client device 110a, 110b and the back-end computing platform 102 may include any one or more of a Personal Area Network (PAN), a Local Area Network (LAN), a Wide Area Networks (WAN) such as the Internet or a cellular network, a cloud network, and/or a point-to-point data link, among other possibilities, where each such data network and/or link may be wireless, wired, or some combination thereof, and may carry data according to any of various different communication protocols. Additionally, the communication between an example client device 110a, 110b and the back-end computing platform 102 may be carried out via an Application Programming Interface (API) provided by the back-end computing platform 102, among other possibilities. Although not shown, the respective communication paths between the example client devices 110a, 110b and the back-end computing platform 102 may also include one or more intermediate systems, examples of which may include a data aggregation system or a host server, among other possibilities. Many other configurations are also possible.

It should be understood that the computing environment 100 is one example of a computing environment in which the disclosed model building and execution framework may be implemented, and that numerous other examples of computing environments are possible as well.

The functionality of the server-side software 103 and client-side software 120 of the disclosed time-series forecasting tool will be now described in further detail.

To begin, at a high level, the example model setup component 104 of the server-side software 103 may cause the back-end computing platform 102 to carry out functionality for obtaining and preparing setup data that is to be utilized by the model building component 105 during the process of building a time-series model that is configured to forecast time-series data for capacity shrink rate. In accordance with the present disclosure, that setup data may include at least (i) model setup parameters and (ii) source data for use in building the new time-series model.

In general, the model setup parameters that are obtained by the model setup component 104 may comprise any parameters that are to be utilized by the model building component 105 during the process of building the new time-series model. Such model setup parameters may take any of various forms.

For instance, one type of model setup parameter that may be obtained by the model setup component 104 may comprise a specification of the target time-series variable that is to be forecast by the new time-series model—in this case, capacity shrink rate for a given call center workforce —as well as a specification of the exogenous variables that are to serve as input(s) to the new time-series model. In this regard, it should be understood that a given call center workforce may be represented at various different levels of granularity. As one possibility, a given call center workforce may include the entire call center workforce that handles customer support call for a given line of business, regardless of the call center's physical location. For example, a business organization that offers financial services may have numerous distinct lines of business (LOBs) including Deposit Servicing, Deposit Acquisition, Electronic Banking, RegE (electronic funds transfer), Personal Loan, Home Loan, and so on. Each line of business may have a corresponding call center workforce that handles customer calls related to that line of business (e.g., for a given country), although the workforce may be spread across various physical call center locations. Accordingly, the time series models discussed herein may obtain source data and forecast capacity shrink rate for a given call center workforce at a line of business level (e.g., nationally). Alternatively, a given call center workforce may be analyzed at a more granular level, perhaps corresponding to a call center's physical location. Other examples are also possible.

Another type of model setup parameter that may be obtained by the model setup component 104 is a specification of time resolution for the new time-series model, which may define the length of the time intervals between consecutive values within the time-series data that is input and output by the new time-series model (i.e., the sampling frequency of the time-series data). In general, the time-series data contemplated herein for forecasting capacity shrink rate is daily data, however other time intervals are also possible. Further, daily time-series data may be aggregated and presented as weekly or monthly data, among other possibilities.

A further type of model setup parameter that may be obtained by the model setup component 104 is a specification of a forecast (or “look-forward”) window for the time-series model, which defines the time window in the future for which the model is to forecast values for the capacity shrink rate. For instance, the forecast window for the new time-series model may begin at the time the model is executed (or at some time thereafter) and extend any number of days, weeks, months, or years into the future. Examples discussed herein contemplate a 12-month forecast window, although other values are also possible (e.g., 6 months into the future, 24 months into the future, 36 months into the future, etc.).

A further type of model setup parameter that may be obtained by the model setup component 104 is a specification of a look-back window for the time-series model, which defines a time window in the past for which the time-series model's input data is to be obtained. For instance, a new time-series model built in accordance with the present disclosure may be configured to receive input data for a time window in the past that takes the form of (i) a rolling window of a fixed length of time (e.g., a 6-month or 12-month look-back window), or (ii) an expandable look-back window that may extend back to the earliest available time for which input data is available for the new time-series model, among other possibilities.

The model setup parameters that are obtained by the model setup component 104 may take various other forms as well.

The model setup component 104 may obtain the model setup parameters in any of various manners. As one possibility, the model setup component 104 may obtain at least some of the model setup parameters via a GUI that enables a user to specify values for certain model setup parameters by typing or otherwise entering the values into the GUI, selecting the values for the model setup parameters from a list of available options that are presented via the GUI, or uploading a data file that contains the values for the model setup parameters, among other possible ways that a user may input model setup parameters via a GUI. In this respect, the model setup component 104 may cause a client device 110 associated with a user to present the GUI for specifying the values for certain model setup parameters and may then receive setup data from the client device 110 that includes values for certain model setup parameters, among other possible ways that the model setup component 104 may obtain model setup parameters via a GUI.

As another possibility, the model setup component 104 may obtain at least some of the model setup parameters by loading those model setup parameters from the data storage layer of the back-end computing platform 102 (or perhaps some other data store). In this respect, the model setup component 104 could be configured to load the predefined model setup parameters by default, or the model setup component 104 could be configured to load the predefined model setup parameters in response to receiving setup data from a client device 110 indicating that a user has requested to use predefined model setup parameters. For example, the GUI for specifying model setup parameters could enable a user to select a “default model setup parameters” option, and if the setup data received from the user's client device 110 indicates that the user has selected this option, the model setup component 104 may load a default set of predefined model setup parameters from the data storage layer of the back-end computing platform 102. Or as another example, the GUI for specifying model setup parameters could enable a user to select between multiple different sets of predefined model setup parameters (e.g., multiple different model setup profiles), and if the setup data received from the user's client device 110 indicates that the user has selected one of these sets, the model setup component 104 may load the selected set of predefined model setup parameters from the data storage layer of the back-end computing platform 102. Other examples are possible as well.

The model setup parameters for the new time-series model may serve to define the input and output features for the new time-series model. For instance, in addition to a sequence of past values (e.g., daily values) for the capacity shrink rate for the given call center workforce from the look-back window, the new time-series model may have additional input features corresponding to each exogenous variable that was specified in the model setup parameters. These additional input features include, for each exogenous variable, (i) a sequence of past values (e.g., daily values) for the exogenous variable, for the given call center workforce, from the look-back window and (ii) a sequence of future values (e.g., daily values) for the exogenous variable that are from the forecast window. In this regard, the sequence of future values are predicted values for each exogenous variable, as will be discussed in more detail below. Further, the specification of a given call center workforce (e.g., for a particular line of business) in the model setup parameters may define the output of the time-series model as a sequence of future values (e.g., daily values) for the capacity shrink rate, for the given call center workforce, during the forecast window.

In view of the above, it will be appreciated that the time-series models that are built and used to forecast capacity shrink rates may differ for each line of business, even if the look-back window and the forecast windows are the same, based on the different input data that is used for each model. Advantageously, this may allow a business organization to identify trends within the historical data that may be present for some lines of business but not others.

As described above, in addition to obtaining the model setup parameters, the model setup component 104 may also obtain source data for use in building the new time-series model, which may generally comprise any data that is utilized by the model building component 105 during the process of building the new time-series model. This source data may take various forms.

For instance, one type of source data that may be obtained by the model setup component 104 is historical data for the target time-series variable that is to be forecast by the new time-series model—in particular, historical data for the capacity shrink rate from the given call center work force specified in the model setup parameters. Similarly, the source data obtained by the model setup component 104 may include historical data for each exogenous variable from the given call center work force specified in the model setup parameters. In this regard, the historical data for the capacity shrink rate and for each exogenous variable may include historical data from within a look-back window (e.g., 2 years) and having a time resolution (e.g., daily) as specified in the model setup parameters.

Yet another type of source data that may be obtained by the model setup component 104 is an indication of holiday data that is relevant to the given call center workforce. In this regard, it will be appreciated that capacity shrink rates may exhibit significant variation on holidays, and in many cases, for a window of days before and/or after certain holidays. For this reason, it can be beneficial for the time-series model to account for these fluctuations in the historical data by attributing them to the holiday in question. Further, by identifying holidays within the historical data, the time-series model can more effectively predict capacity shrink rates on holiday days within the forecast window. Accordingly, the model setup component 104 may obtain holiday data that includes a set of holiday dates and optionally a window of days surrounding each holiday during which capacity shrink rates may be affected.

The model setup component 104 may obtain the source data in any of various manners. As one possibility, the model setup component 104 may obtain at least some of the source data via a GUI that enables a user to input source data for use in building the new time-series model by typing the source data into the GUI, selecting source data from a list of available options that are presented via the GUI, or uploading a data file that contains the source data, among other possible ways that a user may input source data via a GUI. In this respect, the model setup component 104 may cause a client device 110 associated with a user to present the GUI for inputting source data and may then receive user-input source data from the client device 110, among other possible ways that the model setup component 104 may obtain source data via a GUI.

As another possibility, the model setup component 104 may obtain at least some of the source data by accessing and loading such source data from the data storage layer of the back-end computing platform 102 (or perhaps some other data store). In this respect, the model setup component 104 could be configured to access and load the source data in response to receiving setup data from a client device 110 indicating a user's specification of any one or more variables for which source data is to be obtained, such as the target time-series variable, an exogenous variable, or holiday data as discussed above. For example, after receiving model setup data from the client device 110 indicating that a user has specified the capacity shrink rate to be forecast by the new time-series model, the model setup component 104 may locate historical values for the capacity shrink rate within the data storage layer of the back-end computing platform 102 (or perhaps some other data store) and then load those historical values for the capacity shrink rate. As another example, after receiving model setup data from the client device 110 indicating that a user has specified a given exogenous variable that is to serve as an input to the new time-series model, the model setup component 104 may locate historical values for the given exogenous variable within the data storage layer of the back-end computing platform 102 (or perhaps some other data store) and then load those historical values for the exogenous variable. As yet another example, after receiving model setup data from the client device 110 indicating that a user has specified a given call center workforce as the target time-series variable (e.g., a call center workforce within a given country), the model setup component 104 may locate holiday data for the given call center workforce (e.g., holidays within the given country) within the data storage layer of the back-end computing platform 102 (or perhaps some other data store) and then load that holiday data. Other examples are possible as well.

As yet another possibility, the model setup component 104 may obtain at least some of the source data by requesting and receiving it from a third-party data source.

The function of obtaining the source data for use in building the new time-series model may take various other forms as well.

In some situations, the source data obtained by the model setup component 104 may need to undergo further preparation before it is used by the model building component 105. For instance, to the extent that different types of source data include values having different time resolutions than the defined time resolution for the time-series model, one type of data preparation operation performed by the model setup component 104 may involve resampling certain of the source data in order to align the time resolutions of the source data values. For example, if the values for the target time-series variable and/or a given exogenous variable have a different time resolution than the defined time resolution for the time-series model, then the model setup component 104 may down-sample (e.g., via aggregation) or up-sample (e.g., via interpolation) the values for the target time-series variable and/or exogenous variable in order to align the time resolution of that source data with the defined time resolution of the time-series model. Other examples are possible as well.

Another type of preparation that the model setup component 104 performs may involve transforming certain types of source data in a way that captures shrinkage-specific patterns within the data. For example, one of the exogenous variables discussed herein that may be utilized for the disclosed time-series models is agent tenure, where a greater agent tenure tends to result in a lower capacity shrink rate. In this regard, agent tenure as an exogenous variable may be expressed as a set of agent tenure variables, each agent tenure variable corresponding to a proportion of the total number of agents within a given call center workforce having a level of experience (e.g., tenure of a certain length) that tends to align with a given capacity shrink rate. However, historical data for agent tenure may not be collected and stored in a format that captures these types of tenure-specific shrinkage patterns. For example, the historical data for agent tenure may consist of a daily table identifying tenure values for each agent in the agent population of a call center's workforce.

To prepare this type of historical agent tenure data for use by the model building component 105, the model setup component 104 may transform the historical agent tenure data by segmenting it into two or more distinct agent tenure windows that reflect tenure-specific shrinkage patterns. The agent tenure windows are aligned with the set of agent tenure variables that will be used by the time-series model. Once the historical agent tenure data is segmented into windows, the total number of agents that fall within each agent tenure window is expressed as a percentage of the overall agent population. In this way, the format of the historical data for agent tenure is aligned with the format expected by the set of agent tenure variables.

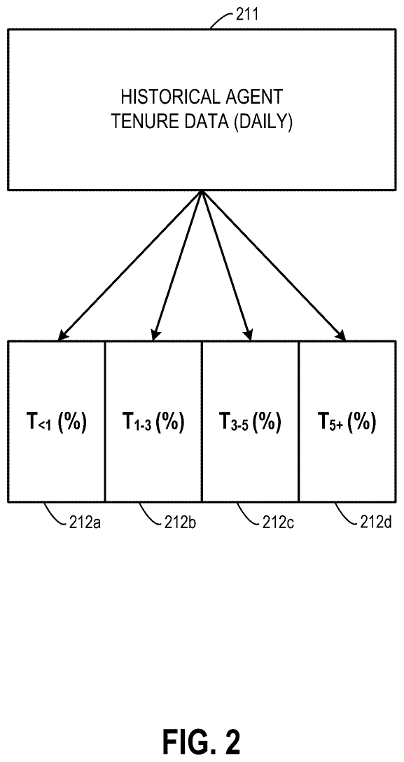

An example of this type of segmentation of historical agent tenure data can be seen in the schematic diagram shown in FIG. 2. As shown, the historical agent tenure data 211 may include daily time-series data indicating a tenure value for each agent in the agent population of the given call center workforce for which capacity shrink rate is to be forecast. The model setup component 104 may segment this data into four distinct tenure windows. In the example shown in FIG. 2, these include a first tenure window 212 a from 0 to 1 year, a second tenure window 212b from 1 to 3 years, a third tenure window 212c from 3 to 5 years, and a fourth tenure window 212d of 5 years or greater. Further, the windows correspond to a set of agent tenure variables that will be used by the time-series model to forecast capacity shrink rate. These include a first agent tenure variable T_{<1}, a second agent tenure variable T₁₋₃, a third agent tenure variable T₃₋₅, and a fourth agent tenure variable T₅₊. Each of these may have a value between 0 and 1, representing the proportion of the agent population that falls into each corresponding tenure window.

Other exogenous variables relating to an agent population, such as agent pay grade, team leader tenure, and the like, may be segmented in a similar way based on the shrinkage patterns observed with respect to those variables.

The model setup component 104 may carry out various other data preparation steps related to the target time-series variable and/or the exogenous variables.

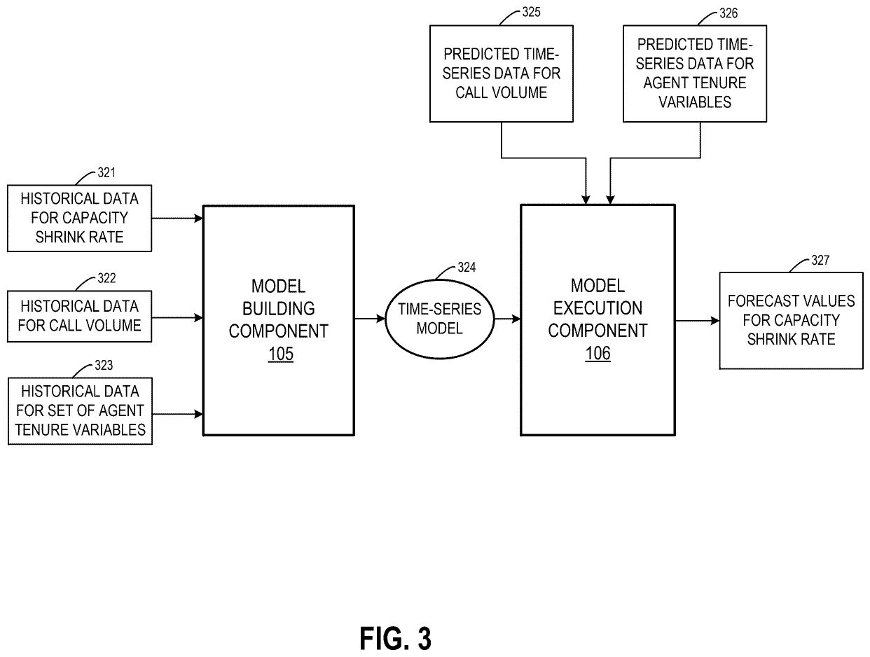

Turning now to FIG. 3, a simplified block diagram is depicted showing example inputs to, and outputs from, the model building component 105 and the model execution component 106 of the back-end computing platform 102. It should be understood, however, that the example shown in FIG. 3 may be carried out by any computing platform that is capable of running the software disclosed herein. Further, it should be understood that the example of FIG. 3 is merely described in this manner for the sake of clarity and explanation and that other implementations are also possible. For example, different inputs and outputs may be present, depending upon the particular embodiment.

FIG. 3 depicts an example in which three different types of source data obtained by the back-end computing platform 102 via the model setup component 104 may be provided as inputs to the model building component 105. The source data shown in FIG. 3 includes historical data for the capacity shrink rate 321, historical data for the call volume 322, and historical data for a set of agent tenure variables 323. In this regard, the historical data for the capacity shrink rate 321 may represent the target time-series variable that is to be forecast by the eventual time-series model and may include daily capacity shrink rate data for a given call center workforce during a designated look-back window, such as one year. However, as discussed above, a different time resolution (e.g., weekly historical data) and/or a different look-back window (e.g., 6 months, 2 years) are also possible.

The historical data for the call volume 322 may correspond to one of the exogenous variables to be considered by the time-series model. In this regard, the historical data for the call volume 322 includes data corresponding to the same call center workforce, and for the same look-back window, as the historical data for the capacity shrink rate 321. Similarly, the historical data for the set of agent tenure variables 323 may correspond to an additional set of exogenous variables to be considered by the time-series model, and similarly includes data corresponding to the same call center workforce, and for the same look-back window, as the historical data for the capacity shrink rate 321. Further, the historical data for the set of agent tenure variables 323 may have been transformed by the model setup component 104 before being provided as input to the model building component 105, as discussed above with reference to FIG. 2, such that the historical data identifies the respective proportion of the agent population that aligns with the tenure window corresponding to each agent tenure variable.

Based on the obtained source data, the model building component 105 of the back-end computing platform 102 may build the time-series model 324, a process that may involve various sub-steps. At a high level, the steps involve dividing the obtained historical data for the look-back window into training and validation datasets, training a plurality of candidate time-series models using different hyperparameter combinations, cross-validating each candidate model to assess model performance, and selecting the best performer among the candidate models.

First, the obtained historical data may be divided into training and validation datasets in various different ways. For example, the back-end computing platform 102 may divide the historical data into a training dataset that that is used to train candidate time-series models and a validation dataset immediately following the end of the training dataset that will be used to evaluate the performance of the trained model. For example, if the historical data includes time-series values (e.g., time-series values for each of the target time-series variable and the exogenous variables) for a look-back window spanning three years from January 2021 to December 2023, the back-end computing platform 102 may divide the historical data into a training dataset that spans the first 24 months, from January 2021 to December 2022, and a validation dataset that spans the 3 months immediately following the training dataset, from January 2023 to March 2023.

In some implementations, the back-end computing platform 102 may divide the historical data into training and validation datasets on an expanding basis, whereby multiple sampling rounds of training and validation datasets are defined. For instance, the example above may represent a first sampling round. In a second round, the training dataset may be expanded by one month into the future to include January 2023. The validation dataset may remain 3 months in duration but may be shifted forward in time by one month to include the 3 months immediately following the new training dataset, namely the months of February 2023 to April 2023. Subsequent sampling rounds for dividing the historical data into expanding training and validation datasets may be carried out in a similar fashion.

Next, the back-end computing platform 102 may train a plurality of candidate time-series models, which may take any of various forms. In one possible implementation, training a plurality candidate time-series models may begin with the back-end computing platform 102 defining a search space of different hyperparameter combinations for the time-series model. In this regard, the search space of different hyperparameter combinations could comprise a grid of all possible hyperparameter combinations for the time-series model if the model building component 105 is configured to use grid search for hyperparameter tuning. Other approaches are also possible, such as a randomly-selected sampling of possible hyperparameter combinations for the given model type if the model building component 105 is configured to use random search for hyperparameter tuning, among other possible examples of a search space of different hyperparameter combinations that could be defined for the plurality of candidate time-series models.

The hyperparameters that are used and the range of values for each hyperparameter within the search space make take any of various forms. For example, one or more hyperparameters (e.g., changepoint_prior_scale in a Prophet type model) may control the flexibility of the time-series model in identifying abrupt changes in the historical data, wherein a greater hyperparameter value (e.g., ranging from 0.01 to 0.5) makes the identification of trends more flexible. As another example, one or more hyperparameters (e.g., fourier_weekly, fourier_monthly, fourier_yearly in a Prophet type model) may determine how the time-series model captures seasonal fluctuations in different scales within the historical data. In this regard, the value of these types of hyperparameters may represent the number of Fourier terms that are used in the training process (e.g., ranging from 1 to 10), where a larger number allows the model to capture more complex seasonal patterns and a lower value represents a simpler and smoother representation of seasonality. Various other types of hyperparameters are also possible and may be included in the search space that is used for training candidate models.

Next, the back-end computing platform 102 may iterate through different hyperparameter combinations in the defined search space, and for each respective hyperparameter combination, the back-end computing platform 102 may generate a candidate time-series model having the respective hyperparameter combination. To accomplish this for a given hyperparameter combination, the back-end computing platform 102 may run a training operation for the model using the defined training dataset (e.g., the training dataset from the first sampling round discussed above). The type of training operation may depend on the type of model that is being used. As one example, the back-end computing platform 102 may run a Prophet type training operation for building a Prophet type time-series model. Other types of time-series models are also contemplated herein, including a Seasonal Autoregressive Integrated Moving-Average with eXogenous regressors (SARIMAX) type of time-series model, an Unobserved Components type of time-series model, an Exponential Smoothing type of time-series model, a Generalized AutoRegressive Conditional Heteroskedasticity (GARCH) type of time-series model, a Vector Autoregression type of timeseries model, a Long Short-term Memory (LSTM) network type of time-series model, among other possibilities. By running the training operation, the back-end computing platform 102 may generate a time-series model that has the given hyperparameter combination.

In some embodiments, it is possible that the back-end computing platform 102 could generate a single candidate time-series model for each hyperparameter combination, such as in a scenario where there is only a single training dataset. However, it is also possible that the back-end computing platform 102 may generate a batch of candidate time-series models for each respective hyperparameter combination, such as in a scenario where there were multiple sampling rounds when diving the historical data into training and validation datasets.

For example, to generate a first batch of candidate time-series models having a first hyperparameter combination, the back-end computing platform 102 may run a first instance of a training operation using the first hyperparameter combination and a first training dataset in order to generate a first instance of a time-series model that has the first hyperparameter combination, a second instance of the training operation using the first hyperparameter combination and a second training dataset in order to generate a second instance of a time-series model that has the first hyperparameter combination, and so on for each other training dataset that is defined. Likewise, the back-end computing platform 102 may carry out similar functionality for each of the other hyperparameter combinations in the defined search space. As a result, the back-end computing platform 102 may generate a first batch of candidate time-series models having a first hyperparameter combination, a second batch of candidate time-series models having a second hyperparameter combination, etc.

Next, the back-end computing platform 102 may apply a hyperparameter tuning technique to the plurality of candidate time-series models in order to identify one particular candidate time-series model that has a most-optimal hyperparameter combination, which may be referred to as the “optimal” time-series model.

At a high level, the functionality of applying a hyperparameter tuning technique to a batch of candidate time-series models (or an individual candidate time-series model for the given hyperparameter combination) may generally involve (i) for each respective hyperparameter combination, evaluating the performance of the instances of a time-series model having the respective hyperparameter combination using the validation datasets that correspond to the training datasets used to generate the instances of the time-series model (e.g., from the divisions of training-validation datasets) and then determining a respective measure of performance for the respective hyperparameter combination, (ii) identifying a particular one of the hyperparameter combinations that delivers the best performance (e.g., the candidate time-series model that most accurately forecasts the values of the target time-series variable), and (iii) selecting a candidate time-series model having the identified hyperparameter combination as the optimal time-series model for the model type. This functionality may take any of various forms.

For instance, as one possible implementation, evaluating the performance of the instances of a time-series model having a given hyperparameter combination using the validation datasets that correspond to the training datasets used to generate the instances of the time-series model may involve the following functionality for each respective instance of the time-series model and its corresponding validation dataset: (i) causing the respective instance of the time-series model to output a respective prediction comprising a forecasted sequence of values for the target time-series variable, (ii) performing a comparison between the respective prediction output by the respective instance of the time-series model and the sequence of ground-truth values for the target time-series variable from the validation dataset, and (iii) based on the comparisons, deriving a respective instance-specific measure of the performance of the respective instance of the time-series model. In this respect, the respective instance-specific measure of the performance of each respective instance of the time-series model having the given hyperparameter combination could take any of various forms, examples of which may include a mean absolute percentage error (MAPE), a weighted mean absolute percentage error (WMAPE), symmetric mean absolute percentage error (SMAPE), or Normalized Mean Absolute Error (NMAE), mean absolute deviation (MAD), mean absolute error (MAE), mean squared error (MSE), or root mean squared error (RMSE), among other possible examples of metrics that quantify the performance of a time-series model.

As noted above, the back-end computing platform 102 may perform this functionality across the batches of model instances that have been generated for each respective hyperparameter combination.

In turn, for each respective hyperparameter combination, the back-end computing platform 102 may determine a respective measure of performance for the respective hyperparameter combination based on the respective instance-specific measures of performance that have been derived for the instances of the time-series model having the respective hyperparameter combination. For example, for a given hyperparameter combination, the back-end computing platform 102 may function to determine a given measure of performance for the given hyperparameter combination by aggregating the respective instance-specific measures of performance (e.g., MAPE values) that have been derived for the instances of the time-series model having the given hyperparameter combination (e.g., by taking an average, a summation, or the like), among other possibilities.

As result of this functionality, the back-end computing platform 102 may produce a respective measure of performance for each respective hyperparameter combination. In turn, the back-end computing platform 102 may identify the particular hypermeter combination that delivers the best measure of performance (e.g., the hypermeter combination having the lowest aggregated MAPE value) and then select a candidate time-series model having the identified hyperparameter combination as the optimal time-series model for the given model type.

While the foregoing describes one possible implementation of functionality for performing hyperparameter tuning in order to identify an optimal time-series model, it should be understood that the back-end computing platform 102 could be configured to apply any hyperparameter tuning technique now known or later developed in order to an optimal time-series model—including but not limited to the possibility that the back-end computing platform 102 may generate and test a single instance of a time-series model for each respective hyperparameter combination, as mentioned above.

After identifying the optimal time series model, the model building component 105 may store an indication of the optimal time series model in the data storage layer of the back-end computing platform 102 so that it can be used by the model execution component 106 and/or other components of the server-side software 103. In the context of FIG. 3, the optimal time series model is shown schematically as an output of the model building component 105, represented by the time-series model 324.

At a high level, the model execution component 106 shown in FIG. 1 and FIG. 3 may cause the back-end computing platform 102 to carry out functionality for executing the time-series model 324 that was built using the model building component 105. In particular, the back-end computing platform 102 may utilize the time-series model 324 to predict forecast values for the target time-series variable—namely, the capacity shrink rate for the call center workforce—during a target timeframe. To do so, the back-end computing platform 102 may receive, as additional inputs, predicted time series data for each of the exogenous variables for which historical data was obtained during the model setup stage discussed above. Accordingly, the predicted time series data that is received as input to the time-series model 324 may take various forms.

In the example shown in FIG. 3, an input to the time-series model 324 may include predicted time-series data for the call volume 325 for the call center workforce during a given target timeframe for which a forecast is desired. For instance, if the target timeframe for the forecast is the next 12 months, with a daily time resolution, the predicted time-series data for the call volume 325 may include predicted daily values for the call center's call volume for the next 12 months.

The predicted time-series data for the call volume 325 may be obtained in various ways. As one possibility, the predicted time-series data for the call volume 325 may be an output from a separate time-series model that is trained and executed using call volume as the target time-series variable. In this regard, a time-series model for predicting call volume may utilize exogenous variables that may be drivers of call volume for the particular call center in question, such as marketing expenditures related to product offerings in the call center's line of business, economic outlooks, among other examples. Further, a time-series model for predicting call volume may be built and/or executed by the back-end computing platform 102 or by a separate computing platform which then provides the predicted call volume data to the back-end computing platform 102. The predicted time-series data for call volume 325 may be obtained in other ways as well.

As another possibility, a user may enter at least some of the predicted time-series data for the call volume 325 into a model execution GUI displayed via a client device 110, perhaps in conjunction with a request to execute the time-series model 324. Thus, the back-end computing platform 102 may receive the predicted time-series data for the call volume 325, among other input data, from the user's client device 110 along with the indication of the user's request to execute the time-series model 324. In this respect, the model execution GUI may enable a user to enter at least some types of input data for use in executing the time-series model 324 by typing such input data into the model execution GUI, selecting such input data from a list of available options that are presented via the model execution GUI, or uploading a data file that contains such input data, among other possible ways that a user may enter input data into the model execution GUI.

Another type of precited data that may be obtained by the back-end computing platform 102 and used as an input to the time-series model 324 may be predicted time-series data for a set of agent tenure variables 326, as shown in FIG. 3. Consistent with the discussion above, the predicted time-series data for the set of agent tenure variables 326 may include values for a set of agent tenure variables that each represent the proportion of agents within the call center population that fall within a respective tenure window.

The predicted time-series data for the set of agent tenure variables 326 may be obtained in various ways. As one possibility, the back-end computing platform 102 may determine the current value of each agent tenure variable based on the current agent population at the time the time-series model 324 is executed and then use these values for the predicted time-series data. As another possibility, the back-end computing platform 102 may determine the distribution of agents across each of the agent tenure windows for a given look-back period (e.g., 2 months, 4 months, 6 months) and then use an average value across this look-back window for each of the agent tenure variables. Other approaches are also possible, including approaches that incorporate an assumption that the overall tenure of the agent population will naturally increase during the target timeframe, depending on the length of the target timeframe. For instance, if the target timeframe is the next 12 months, the predicted time-series data for the set of agent tenure variables 326 may incorporate an assumption that some agents within the agent population will progress from one agent tenure window (e.g., less than 1 year) to the next, more experienced agent tenure window (e.g., 1 to 3 years). As yet another possibility, at least a portion of the predicted time-series data for the set of agent tenure variables 326 may be received as input from client device 110 via a model execution GUI, as discussed above. Numerous other possibilities also exist.

As shown in FIG. 3, the predicted time-series data for the call volume 325 and the predicted time-series data for the set of agent tenure variables 326 may be provided to the model execution component 106 to be used as inputs when executing the time-series model 324. The resulting output from executing the time-series model 324 is a sequence of forecast values for the capacity shrink rate 327 for the call center during the target timeframe. In this regard, the forecast values for the capacity shrink rate 327 may take various forms, depending on the model setup parameters discussed above. For instance, the time-series model 324 may output a sequence of forecast values for the capacity shrink rate at a daily level during the target timeframe. As noted above, the target timeframe may be the next 6 months or 12 months, among other possible timeframes for which a business organization may wish to forecast capacity shrink rates. In some cases, the time-series model 324 may optionally aggregate the forecast data for capacity shrink rate that is output at a relatively granular level, such as daily data, into weekly or monthly values as part of its output. This may allow business organizations to analyze the capacity shrink rate for the call center workforce and make workforce planning decisions over a longer time horizon, among other possible benefits.

The back-end computing platform 102 may also take other actions based on the predicted sequence of forecast values for the capacity shrink rate for the call center workforce. For example, the back-end computing platform 102 may utilize the forecasted values generated by the model execution component 106 as input values into some other downstream data science model. As another example, the back-end computing platform 102 may generate notifications and/or alerts based on the forecasted values for the capacity shrink rate, which may be presented to a user via a client device 110. Other examples of actions taken by the back-end computing platform 102 based on the predicted sequence of forecast values for the target time-series variable are possible as well.

The functionality that is carried out by the model execution component 106 in order to execute the time-series models discussed herein may take various other forms as well.

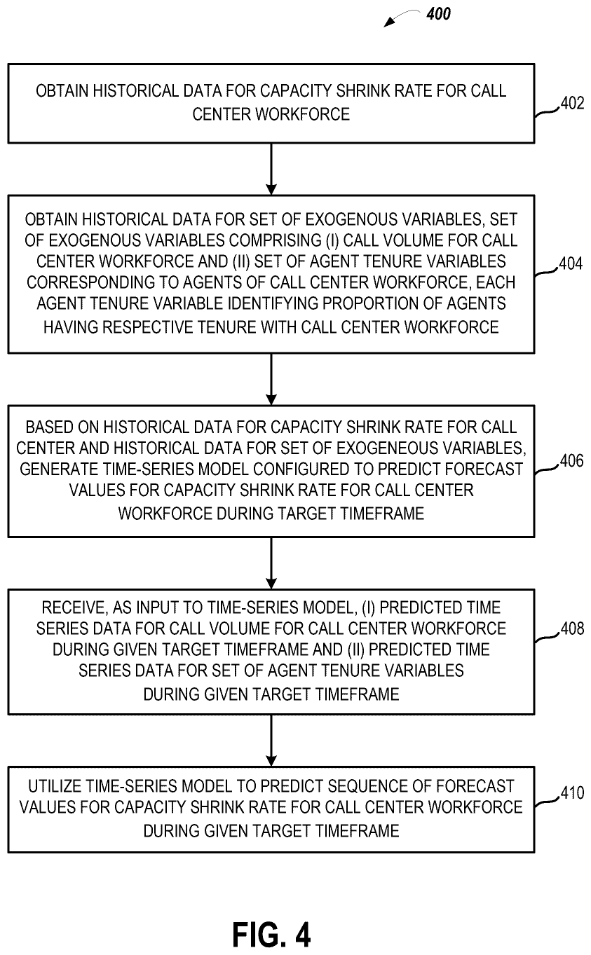

Turning now to FIG. 4, an example flowchart 400 is shown that depicts example functionality for building and executing a time-series model according to the new framework discussed herein. For purposes of illustration, the example flowchart 400 of FIG. 4 is described as being carried out by the back-end computing platform 102 of FIG. 1, but it should be understood that the example functionality of FIG. 4 may be carried out by any computing platform that is capable of running the software disclosed herein. Further, it should be understood that the example functionality of FIG. 4 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular embodiment.

As shown in FIG. 4, the example flowchart 400 may begin at block 402 with the back-end computing platform 102 obtaining historical data for a capacity shrink rate for a call center workforce.

At block 404, the back-end computing platform 102 may obtain historical data for a set of exogenous variables. As discussed above, the set of exogenous variables may take various forms, including call volume for the call center workforce, which may be one potential driver of capacity shrink rate. In addition, the back-end computing platform 102 may obtain historical data for a set of agent tenure variables corresponding to agents of the call center workforce, where each agent tenure variable identifies a proportion of the agents having a respective tenure with the call center workforce.

At block 406, based on the historical data for the capacity shrink rate for the call center workforce and the historical data for the set of exogenous variables, the back-end computing platform 102 may generate a time-series model that is configured to predict forecast values for the capacity shrink rate for the call center workforce during a target timeframe. As discussed above, this may involve training and cross validation of multiple candidate time-series models using different combinations of hyperparameters until an optimal hyperparameter combination is identified, and a corresponding time-series model that uses the identified hyperparameter combination is selected.

At block 408, the back-end computing platform 102 may receive, as input to the generated time-series model, (i) predicted time series data for the call volume for the call center workforce during a given target timeframe and (ii) predicted time series data for the set of agent tenure variables during the given target timeframe.

At block 410, the back-end computing platform 102 may utilize the time-series model to predict a sequence of forecast values for the capacity shrink rate for the call center workforce during the given target timeframe.

In addition to the model building and execution operations discussed above, the disclosed framework may also include an approach for monitoring the performance of a generated time-series model. Referring again to FIG. 1, the back-end computing platform 102 may include a model evaluation component 107 as part of the server-side software 103. At a high level, the model evaluation component 107 may cause the back-end computing platform 102 to carry out functionality that enables users to engage in any of various tasks for evaluating and/or adjusting the time-series model that is built using the disclosed framework. These tasks may take any of various forms.

As one possibility, the back-end computing platform 102 may execute the time-series model 324 on a monthly basis to forecast the capacity shrink rate for the next 6-month period. At the end of each such 6-month period, on a rolling basis, the back-end computing platform 102 may compare the 6 month forecast to the actual capacity shrink rate this is observed and determine the model's performance, such as by determining the MAPE. In this regard, the back-end computing platform 102 may determine a threshold MAPE value over which the time-series model 324 is considered to be unstable. For example, a MAPE value in the range of 5-6% may be considered average, whereas a MAPE value over 15% may be considered unstable such that the business organization may consider discontinuing use of the model, depending on risk tolerances. In some implementations, the model evaluation component 107 may flag a time-series model that is approaching these levels of performance (e.g., a MAPE value over 10%) so that potential reasons for the change, such as trend or seasonality shifts, external economic events, and the like may be investigated. This, in turn, may lead to insights for reconfiguring the model setup parameters for building a new, improved time-series model according to the framework discussed herein.

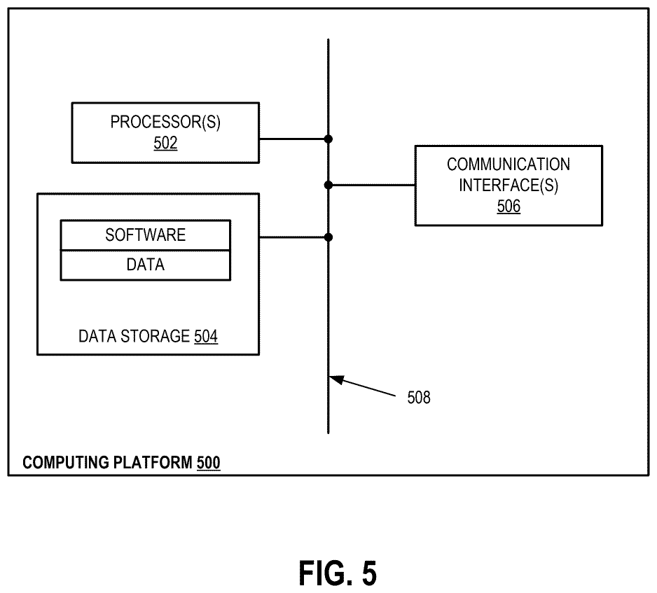

Turning now to FIG. 5, a simplified block diagram is provided to illustrate some structural components that may be included in an example computing platform 500 that may be configured to perform some or all of the server-side functions disclosed herein. At a high level, computing platform 500 may generally comprise any one or more computer systems (e.g., one or more servers) that collectively include one or more processors 502, data storage 504, and one or more communication interfaces 506, all of which may be communicatively linked by a communication link 508 that may take the form of a system bus, a communication network such as a public, private, or hybrid cloud, or some other connection mechanism. Each of these components may take various forms.

For instance, the one or more processors 502 may comprise one or more processor components, such as one or more central processing units (CPUs), graphics processing unit (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 502 could comprise processing components that are distributed across a plurality of physical computing devices connected via a network, such as a computing cluster of a public, private, or hybrid cloud.

In turn, data storage 504 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 504 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 5, data storage 504 may be capable of storing both (i) program instructions that are executable by the one or more processors 502 such that the computing platform 500 is configured to perform any of the various functions disclosed herein (including but not limited to any of the server-side functions discussed above), and (ii) data that may be received, derived, or otherwise stored by computing platform 500.

The one or more communication interfaces 506 may comprise one or more interfaces that facilitate communication between computing platform 500 and other systems or devices, where each such interface may be wired and/or wireless and may communicate according to any of various communication protocols. As examples, the one or more communication interfaces 506 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the computing platform 500 may additionally have an I/O interface that includes or provides connectivity to I/O components that facilitate user interaction with the computing platform 500, such as a keyboard, a mouse, a trackpad, a display screen, a touch-sensitive interface, a stylus, a virtual-reality headset, and/or one or more speaker components, among other possibilities.

It should be understood that computing platform 500 is one example of a computing platform that may be used with the embodiments described herein. Numerous other arrangements are possible and contemplated herein. For instance, in other embodiments, the computing platform 500 may include additional components not pictured and/or more or less of the pictured components.

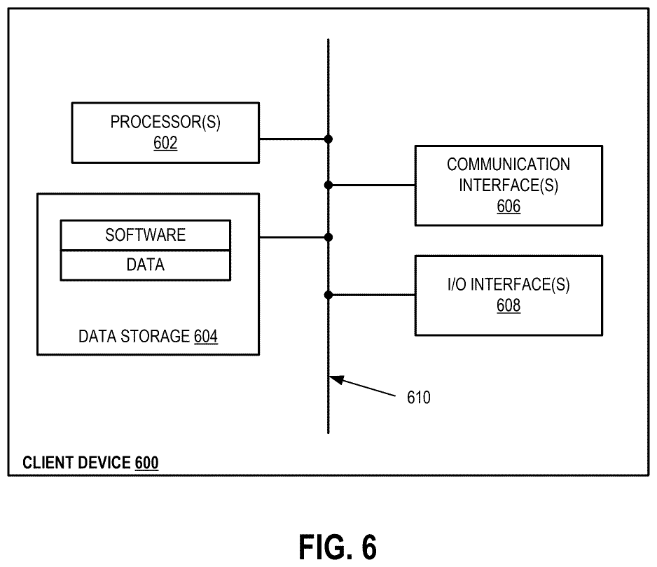

Turning next to FIG. 6, a simplified block diagram is provided to illustrate some structural components that may be included in an example client device 600 that may be configured to perform some or all of the client-side functions disclosed herein. At a high level, the example client device 600 may include one or more processors 602, data storage 604, one or more communication interfaces 606, and an I/O interface 608, all of which may be communicatively linked by a communication link 610 that may take the form a system bus and/or some other connection mechanism. Each of these components may take various forms.

For instance, the one or more processors 602 of the example client device 600 may comprise one or more processor components, such as one or more CPUs, GPUs, ASICs, DSPs, and/or programmable logic devices such as FPGAs, among other possible types of processing components.

In turn, the data storage 604 of the example client device 600 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 6, data storage 604 may be capable of storing both (i) program instructions that are executable by the one or more processors 602 of the example client device 600 such that the client device 600 is configured to perform any of the various functions disclosed herein (including but not limited to any of the client-side functions discussed above), and (ii) data that may be received, derived, or otherwise stored by the client device 600.

The one or more communication interfaces 606 may comprise one or more interfaces that facilitate communication between the client device 600 and other systems or devices, where each such interface may be wired and/or wireless and may communicate according to any of various communication protocols. As examples, the one or more communication interfaces 606 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 608 may generally take the form of (i) one or more input interfaces that are configured to receive and/or capture information at the example client device 600 and (ii) one or more output interfaces that are configured to output information from the example client device 600 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of I/O interface may include or provide connectivity to output components such as a display screen and/or an audio speaker, among other possibilities.

It should be understood that the example client device 600 is one example of a client device that may be used with the example embodiments described herein. Numerous other arrangements are possible and contemplated herein. For instance, in other embodiments, the example client device 600 may include additional components not pictured and/or more or fewer of the pictured components.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

We claim:

1. A computing platform comprising:
at least one network interface;
at least one processor;
at least one non-transitory computer-readable medium; and
program instructions stored on the at least one non-transitory computer-readable medium that, when executed by the at least one processor, cause the computing platform to:
obtain historical data for a capacity shrink rate for a call center workforce;
obtain historical data for a set of exogenous variables, the set of exogenous variables comprising (i) call volume for the call center workforce and (ii) a set of agent tenure variables corresponding to agents of the call center workforce, each agent tenure variable identifying a proportion of the agents having a respective tenure with the call center workforce;
based on the historical data for the capacity shrink rate for the call center workforce and the historical data for the set of exogenous variables, generate a time-series model that is configured to predict forecast values for the capacity shrink rate for the call center workforce during a target timeframe;
receive, as input to the time-series model, (i) predicted time series data for the call volume for the call center workforce during a given target timeframe and (ii) predicted time series data for the set of agent tenure variables during the given target timeframe; and
utilize the time-series model to predict a sequence of forecast values for the capacity shrink rate for the call center workforce during the given target timeframe.

2. The computing platform of claim 1, further comprising program instructions that, when executed by the at least one processor, cause the computing platform to:
before generating the time-series model, transform the historical data for the set of agent tenure variables by segmenting it into two or more agent tenure windows, wherein each agent tenure variable identifies a proportion of agents of the call center workforce that falls within a corresponding agent tenure window.

3. The computing platform of claim 2, wherein the two or more agent tenure windows comprise a first tenure window from 0 to 1 years, a second tenure window from 1 to 3 years, a third tenure window from 3 to 5 years, and a fourth tenure window of 5 years or greater.

4. The computing platform of claim 1, wherein the program instructions that, when executed by the at least one processor, cause the computing platform to generate a time-series model comprise program instructions stored on the at least one non-transitory computer-readable medium that, when executed by the at least one processor, cause the computing platform to:
train a plurality of candidate time-series models that are configured to predict forecast values for the capacity shrink rate for the call center workforce, wherein each time-series model in the plurality has a different hyperparameter combination;
based on an evaluation of the plurality of candidate time-series models, determine a respective measure of performance for each of the different hyperparameter combinations;
identify a hyperparameter combination that has a best measure of performance relative to other hyperparameter combinations; and
select a candidate time-series model having the identified hyperparameter combination as the generated time-series model.

5. The computing platform of claim 4, wherein the different hyperparameter combinations are selected using grid search.

6. The computing platform of claim 4, wherein the program instructions that, when executed by the at least one processor, cause the computing platform to determine a respective measure of performance for each different hyperparameter combination comprise program instructions stored on the at least one non-transitory computer-readable medium that, when executed by the at least one processor, cause the computing platform to:
determine, for each different hyperparameter combination, a respective mean absolute percentage error (MAPE) value.

7. The computing platform of claim 1, wherein the set of exogenous variables further comprises one or more of (iii) agent geographic location for agents of the call center workforce, (iv) agent pay grade for agents of the call center workforce, or (vi) team leader tenure for agents of the call center workforce.

8. The computing platform of claim 1, further comprising program instructions that, when executed by the at least one processor, cause the computing platform to:
determine a set of current values for the set of agent tenure variables, wherein the predicted time series data for the set of agent tenure variables during the given target timeframe comprises the set of current values for the set of agent tenure variables.

9. The computing platform of claim 1, further comprising program instructions that, when executed by the at least one processor, cause the computing platform to:
receive, from a client device, input indicating (i) the historical data for the capacity shrink rate and (ii) the historical data for a set of exogenous variables; and
transmit the predicted sequence of forecast values for the capacity shrink rate for the call center workforce during the target timeframe to the client device for display via the client device.

10. A non-transitory computer-readable medium, wherein the non-transitory computer-readable medium is provisioned with program instructions that, when executed by at least one processor, cause a computing platform to:
obtain historical data for a capacity shrink rate for a call center workforce;
obtain historical data for a set of exogenous variables, the set of exogenous variables comprising (i) call volume for the call center workforce and (ii) a set of agent tenure variables corresponding to agents of the call center workforce, each agent tenure variable identifying a proportion of the agents having a respective tenure with the call center workforce;
based on the historical data for the capacity shrink rate for the call center workforce and the historical data for the set of exogenous variables, generate a time-series model that is configured to predict forecast values for the capacity shrink rate for the call center workforce during a target timeframe;
receive, as input to the time-series model, (i) predicted time series data for the call volume for the call center workforce during a given target timeframe and (ii) predicted time series data for the set of agent tenure variables during the given target timeframe; and
utilize the time-series model to predict a sequence of forecast values for the capacity shrink rate for the call center workforce during the given target timeframe.

11. The non-transitory computer-readable medium of claim 10, wherein the non-transitory computer-readable medium is also provisioned with program instructions that, when executed by at least one processor, cause a computing platform to:
before generating the time-series model, transform the historical data for the set of agent tenure variables by segmenting it into two or more agent tenure windows, wherein each agent tenure variable identifies a proportion of agents of the call center workforce that falls within a corresponding agent tenure window.

12. The non-transitory computer-readable medium of claim 11, wherein the two or more agent tenure windows comprise a first tenure window from 0 to 1 years, a second tenure window from 1 to 3 years, a third tenure window from 3 to 5 years, and a fourth tenure window of 5 years or greater.

13. The non-transitory computer-readable medium of claim 10, wherein the program instructions that, when executed by the at least one processor, cause the computing platform to generate a time-series model comprise program instructions stored on the at least one non-transitory computer-readable medium that, when executed by the at least one processor, cause the computing platform to:
train a plurality of candidate time-series models that are configured to predict forecast values for the capacity shrink rate for the call center workforce, wherein each time-series model in the plurality has a different hyperparameter combination;
based on an evaluation of the plurality of candidate time-series models, determine a respective measure of performance for each of the different hyperparameter combinations;
identify a hyperparameter combination that has a best measure of performance relative to other hyperparameter combinations; and
select a candidate time-series model having the identified hyperparameter combination as the generated time-series model.

14. The non-transitory computer-readable medium of claim 13, wherein the different hyperparameter combinations are selected using grid search.

15. The non-transitory computer-readable medium of claim 13, wherein the program instructions that, when executed by the at least one processor, cause the computing platform to determine a respective measure of performance for each different hyperparameter combination comprise program instructions stored on the at least one non-transitory computer-readable medium that, when executed by the at least one processor, cause the computing platform to:
determine, for each different hyperparameter combination, a respective mean absolute percentage error (MAPE) value.

16. The non-transitory computer-readable medium of claim 10, wherein the set of exogenous variables further comprises one or more of (iii) agent geographic location for agents of the call center workforce, (iv) agent pay grade for agents of the call center workforce, or (vi) team leader tenure for agents of the call center workforce.

17. The non-transitory computer-readable medium of claim 10, wherein the non-transitory computer-readable medium is also provisioned with program instructions that, when executed by at least one processor, cause a computing platform to:
determine a set of current values for the set of agent tenure variables, wherein the predicted time series data for the set of agent tenure variables during the given target timeframe comprises the set of current values for the set of agent tenure variables.

18. The non-transitory computer-readable medium of claim 10, wherein the non-transitory computer-readable medium is also provisioned with program instructions that, when executed by at least one processor, cause a computing platform to:
receive, from a client device, input indicating (i) the historical data for the capacity shrink rate and (ii) the historical data for a set of exogenous variables; and
transmit the predicted sequence of forecast values for the capacity shrink rate for the call center workforce during the target timeframe to the client device for display via the client device.

19. A method carried out by a computing platform, the method comprising:
obtaining historical data for a capacity shrink rate for a call center workforce;
obtaining historical data for a set of exogenous variables, the set of exogenous variables comprising (i) call volume for the call center workforce and (ii) a set of agent tenure variables corresponding to agents of the call center workforce, each agent tenure variable identifying a proportion of the agents having a respective tenure with the call center workforce;
based on the historical data for the capacity shrink rate for the call center workforce and the historical data for the set of exogenous variables, generating a time-series model that is configured to predict forecast values for the capacity shrink rate for the call center workforce during a target timeframe;
receiving, as input to the time-series model, (i) predicted time series data for the call volume for the call center workforce during a given target timeframe and (ii) predicted time series data for the set of agent tenure variables during the given target timeframe; and
utilizing the time-series model to predict a sequence of forecast values for the capacity shrink rate for the call center workforce during the given target timeframe.

20. The method of claim 19, further comprising:
before generating the time-series model, transforming the historical data for the set of agent tenure variables by segmenting it into two or more agent tenure windows, wherein each agent tenure variable identifies a proportion of agents of the call center workforce that falls within a corresponding agent tenure window.
